(19) United States
(12) Patent Application Publication
(10) Pub. No.: US 2011/0293903 A1
(43) Pub. Date: Dec. 1, 2011

(54) WAVE SOLDERING APPARATUS TO APPLY BUOYANCY, SOLDERING METHOD, AND METHOD OF FORMING SOLDER BUMPS FOR FLIP CHIPS ON A SUBSTRATE

(75) Inventors: Ky-hyun JUNG, Cheonan-si (KR); Eduard Kurgie, Suwon-si (KR); Jae-yong Park, Cheonan-si (KR); Ho-geon Song, Suwon-si (KR); Jung-hyeon Kim, Hwaseong-si (KR)

(73) Assignee: Samsung Electronics Co., Ltd., Suwon-si (KR)

(21) Appl. No.: 13/112,112

(22) Filed: May 20, 2011

(30) Foreign Application Priority Data
May 25, 2010 (KR) 10-2010-0048618

(51) Int. Cl. B23K 1/00; B32B 3/14; B23K 35/14

(52) U.S. Cl. 428/198; 228/43; 228/253

(57) ABSTRACT

The present general inventive concept includes a wave soldering apparatus, a soldering method using the wave soldering apparatus, and a method of forming a solder bump for a flip chip. The wave soldering apparatus includes a solder bath containing a molten solder. A nozzle is arranged in the solder bath so as to upwardly spout the molten solder toward a bottom surface of a substrate that passes an upper portion of the solder bath. A liquid that is separated from the molten solder is contained in a downstream area of the solder bath, and buoyancy is applied to the molten solder, which is adhered to the substrate, by the liquid. Since the amount of the molten solder adhered to the substrate is increased by the buoyancy, it is possible to form the solder bump to have a height sufficient to use it as a flip chip.

### CROSS-REFERENCE TO RELATED APPLICATIONS

This application claims priority under 35 U.S.C. §119 from Korean Patent Application No. 10-2010-0048618, filed on May 25, 2010, in the Korean Intellectual Property Office, the disclosure of which is incorporated herein in its entirety by reference.

### BACKGROUND

1. Field of the General Inventive Concept

The general inventive concept relates to a wave soldering apparatus, and more particularly, to a wave soldering apparatus to apply buoyancy to a molten solder, a soldering method, and a method of forming a solder bump for a flip chip.

2. Description of the Related Art

In line with the increasing demand for high speed line characteristics and high performances of semiconductor integrated circuits (I/Cs), the number of inputs/outputs (I/O) has been increased so that the final shape of semiconductor I/Cs has been changed from a wire bonding type to a flip chip type. However, the flip chip type is disadvantageous with regard to market competitiveness due to its higher manufacturing costs than a general ball grid array (BGA) type. The most efficient method to reduce the manufacturing costs of flip chip type semiconductor I/Cs is to perform a solder bump forming operation via a low-cost method instead of an electro-plating method. In this regard, it is possible to consider use of a wave soldering apparatus so as to form a solder bump for a flip chip.

The wave soldering apparatus performs a soldering operation while a molten solder is flown onto a substrate. Also, the wave soldering apparatus is used to perform a soldering operation in relation to a pin through hole (PTH) insert part, or to stack a thin small outline package (TSOP). However, the solder bump formed by using the wave soldering apparatus has a very small height that is insufficient to use the solder bump as a flip chip.

### SUMMARY

Features and utilities of the present general inventive concept will be set forth in part in the description which follows and, in part, will be obvious from the description, or may be learned by practice of the general inventive concept

The foregoing and/or other aspects and utilities of the present general inventive concept may be achieved by providing a wave soldering apparatus including a solder bath frame containing molten solder in a solder bath, a nozzle arranged in the solder bath frame to upwardly spout the molten solder toward a bottom surface of a substrate that passes a upper portion of the solder bath in the solder bath frame, and a unit to contain a liquid different than the molten solder in the solder bath frame to apply a buoyancy force of the liquid to the molten solder attached to the substrate.

The liquid may be held in a downstream area of the solder bath with respect to a moving direction of the substrate and the nozzle.

A pump may be arranged in the downstream area of the solder bath so as to make the liquid rise.

A collecting port may be arranged around the downstream area of the solder bath so as to collect the liquid that overflows from the solder bath. The collecting port may be connected to the downstream area of the solder bath via a connection path that is formed in the solder bath of the solder bath frame.

The liquid may include oil or a flux, which does not chemically react with the molten solder and is physically separated from the molten solder. The liquid may have a specific weight lower than a specific weight of the molten solder, and may also have a vaporization temperature higher than a melting temperature of the molten solder.

A preliminary nozzle may be arranged in an upstream area of the solder bath with respect to a moving direction of the substrate and the nozzle.

The foregoing and/or other aspects and utilities of the present general inventive concept may also be achieved by providing a soldering method including the operations of upwardly spouting a molten solder toward a bottom surface of a substrate that passes an upper portion of a solder bath containing the molten solder, and adhering the molten solder to a bottom surface of the substrate, and applying a buoyancy force to the molten solder to adhere the solder to the bottom surface of the substrate to form a plurality of solder bumps.

The solder bath may contain a liquid that does not chemically react with the molten solder and is physically separated from the molten solder, and the buoyancy force may be applied to the molten solder by the liquid.

The soldering method may further include the operation of raising the liquid and then applying an upward flow force generated by an upward flow of the liquid to the molten solder that is adhered to the bottom surface of the substrate.

The foregoing and/or other aspects and utilities of the present general inventive concept may also be achieved by providing a method of forming a solder bump for a flip chip, the method including the operation of forming the solder bump by adhering the molten solder to a plurality of pads formed on the bottom surface of the substrate by performing the soldering method.

Application of the buoyancy force may increase a height of the formed solder bumps to a height greater than a height that would result without the application of the force.

The liquid may have a specific weight lower than a specific weight of the molten solder.

The foregoing and/or other aspects and utilities of the present general inventive concept may also be achieved by providing an apparatus to form solder bumps on a substrate including a solder bath frame to hold a solder bath including molten solder, a first nozzle positioned in an upstream area of the solder bath frame to form a preliminary solder bump on the substrate, a second nozzle positioned in a downstream area of the solder bath frame to form a secondary solder bump on the preliminary bump, and a collecting port adjacent the downstream area to cycle a liquid different from the molten solder through the collecting port and downstream area.

The apparatus may further include a pump arranged in the downstream area of the solder bath frame to raise the liquid to a predetermined height adjacent a top of the solder bath frame within the downstream area.

The predetermined height can be changed to form solder bumps having different heights.

The molten solder may accumulate at a bottom of the solder bath frame and the liquid may accumulate above the molten solder based on an absence of a chemical reaction between the molten solder and the liquid.

A height of the solder bumps may be increased as a result of a buoyancy force and an upward flow force of the liquid.

The foregoing and/or other aspects and utilities of the present general inventive concept may also be achieved by providing a substrate formed by upwardly spouting a molten solder toward a bottom surface of a substrate that passes an upper portion of a solder bath containing the molten solder, and adhering the molten solder to a bottom surface of the substrate and applying a buoyancy force to the molten solder to adhere the solder to the bottom surface of the substrate to form a plurality of solder bumps.

The foregoing and/or other aspects and utilities of the present general inventive concept may also be achieved by providing a substrate including a body, a bottom surface of the body formed with at least one pad thereon separated by a plurality of flux units, and a solder bump formed on the pad, the solder bump having a width that tapers toward the center and a height significantly higher than the flux units.

### BRIEF DESCRIPTION OF THE DRAWINGS

These and other features and utilities of the present general inventive concept will be apparent and more readily appreciated from the following detailed description of the embodiments, taken in conjunction with the accompanying drawings in which:

FIG. 1 is a diagram illustrating a wave soldering apparatus according to an embodiment of the general inventive concept;

FIG. 2 is a magnified diagram illustrating an area A of FIG. 1;

FIG. 3A illustrates a process in which a molten solder is adhered to a substrate when a buoyancy is not applied to a molten solder of the general inventive concept; and

FIG. 3B illustrates a process in which the molten solder is adhered to the substrate when buoyancy is applied to the molten solder by the wave soldering apparatus of FIG. 1.

FIG. 4 illustrates an enlarged view of a solder bump formed on a substrate of the general inventive concept.

### DETAILED DESCRIPTION OF THE PREFERRED EMBODIMENTS

Hereinafter, the general inventive concept will be described in detail by explaining a wave soldering apparatus, a soldering method, and a method of forming a solder bump for a flip chip according to exemplary embodiments of the general inventive concept with reference to the attached drawings. Like reference numerals in the drawings denote like elements.

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. In the drawings, lengths and sizes of layers and regions may be exaggerated for clarity. Like reference numerals refer to like elements throughout. As used herein, the term “and/or” includes any and all combinations of one or more of the associated listed items.

The terms used herein are for the purpose of describing particular embodiments only and is not intended to be limiting of the general inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof.

It will be understood that terms such as “top”, “bottom”, “upper” and “lower” are relative terminology and are not meant to be interpreted to mean that a particular component or apparatus may be oriented only in a manner illustrated or described. Rather, often when using schematic and other illustrations, elements are oriented in a particular manner to illustrate features thereof, and features may be labelled “top”, “bottom”, etc. Thus an upper side of a feature, when turned upside-down, may be described as lower surface, but not meant to be limited to that orientation. Thus, the use of such relative terminology to position orientation, absent particular language relating one feature to another, should not be viewed as limiting the interpretation of features to those described or illustrated using these and related terms.

It will be understood that, although the terms first, second, third, etc., may be used herein to describe various elements, components, regions, layers and/or sections, these elements, components, regions, layers and/or sections should not be limited by these terms.

These terms are only used to distinguish one element, component, region, layer or section from another region, layer or section. Thus, a first element, component, region, layer or section discussed below could be termed a second element, component, region, layer or section without departing from the teachings of the present general inventive concept.

Embodiments of the general inventive concept are described herein with reference to schematic illustrations of idealized embodiments (and intermediate structures) of the general inventive concept. As such, variations from the shapes of the illustrations as a result, for example, of manufacturing techniques and/or tolerances, are to be expected. Thus, embodiments of the general inventive concept should not be construed as limited to the particular shapes of regions illustrated herein but are to include deviations in shapes that result, for example, from manufacturing.

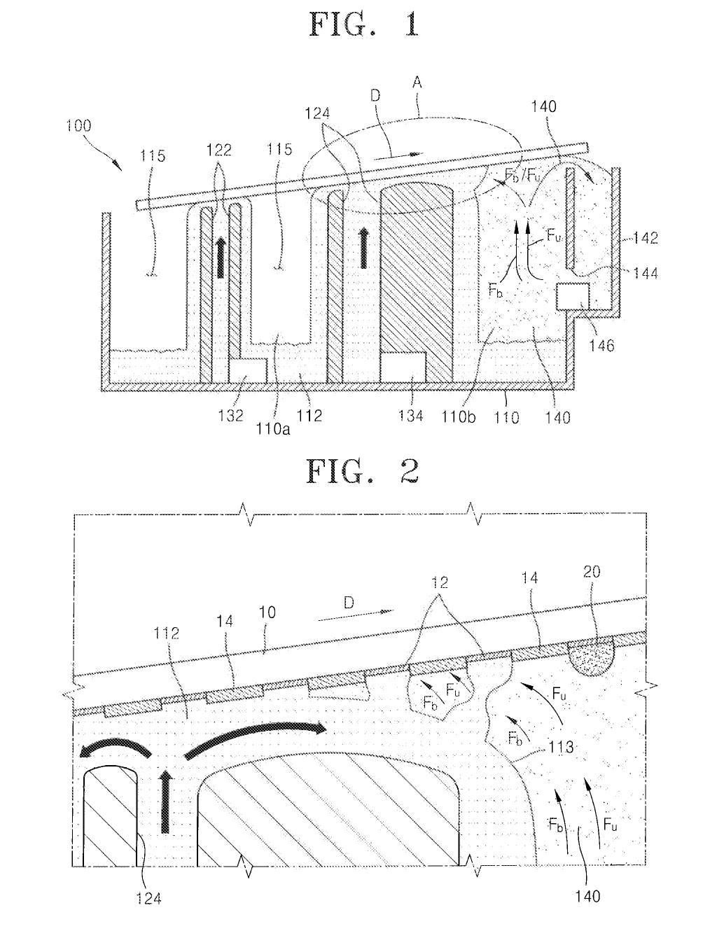

FIG. 1 is a diagram illustrating a wave soldering apparatus 100 according to an embodiment of the general inventive concept. FIG. 2 is a magnified diagram illustrating an area A of FIG. 1.

Referring to FIGS. 1 and 2, the wave soldering apparatus 100 performs a soldering operation while a molten solder 112 is flown on a substrate 10. The substrate 10 may be a semiconductor wafer, a printed circuit board (PCB), or the like. The wave soldering apparatus 100 includes a solder bath frame 110 to encompass a solder bath to accommodate the molten solder 112 at a proper temperature. The substrate 10 to be soldered is disposed at an upper portion of the solder bath frame 110 and moves in a direction, e.g., in a direction marked by an arrow D from an upstream area 110a of the solder bath frame 110 to a downstream area 110b thereof. The substrate 10 may be disposed so as to upwardly slope in the moving direction or may be disposed to move at a steady height level to a bottom surface of the solder bath frame 110.

The solder bath frame 110 may have a structure in which a nozzle 124 is arranged between the upstream area 110a and the downstream area 110b to upwardly spout the molten solder 112 toward a bottom surface of the substrate 10 that passes over or on top of the upper portion of the solder bath frame 110 that contains the solder bath. A pump 134 may be arranged adjacent to a lower portion of the nozzle 124. The pump 134 takes in the molten solder 112 from the solder bath and transmits the molten solder 112 to the upper portion of the solder bath frame 110 via the nozzle 124. The molten solder 112 may then be discharged in a waterfall manner from a top end of the nozzle 124 and flow back to the solder bath in the frame 110 to be used again. In general, a top surface of the molten solder 112 flowing in the aforementioned manner is referred to as a wave 113. In operation, the bottom surface of the substrate 10 contacts or is contacted by the wave 113 of the molten solder 112, and the molten solder 112 is adhered to the bottom surface of the substrate 10 to be soldered.

The solder bath frame 110 holding the solder bath may be divided into the upstream area 110a and the downstream area 110b according to the moving direction of the substrate 10 and the nozzle 124. A preliminary nozzle 122 may be arranged in the upstream area 110a of the solder bath 110. The preliminary nozzle 122 is distant from the nozzle 124, and also upwardly spouts the molten solder 112 toward the bottom surface of the substrate 10. A pump 132 may be arranged adjacent to a lower portion of the preliminary nozzle 122. The preliminary nozzle 122 may be used to form a preliminary amount of molten solder 112 on pads 12 of the substrate 10 before the substrate is transferred to the nozzle 124.

Pressurized gas 115 may be formed the in area between the preliminary nozzle 122 and nozzle 124, within the upstream area 110a. The pressurized gas 115 functions to normalize and regulate the flow of the molten solder 112 discharged from the pump 132 as the molten solder 112 flows on both sides of the nozzle 122 and adjacent the nozzle 124. The pressurized gas 115 may be pumped into the upstream area 110a and other areas of the solder bath frame via inlet tubes (not illustrated). The pressure of the pressurized gas 115 may be monitored and increased or decreased to adjust the flow of the molten solder within the solder bath frame.

The present general inventive concept includes an apparatus and method to apply buoyancy via a buoyancy force to the molten solder 112 upon formation of solder bumps that are to be adhered to the substrate 10. The application of a buoyancy force to the molten solder 112 to form solder bumps is arranged in the downstream area 110b of the solder bath 110. The apparatus and method may include a liquid 140 that is circulated and held at a predetermined height in the downstream area 110b of the solder bath frame 110. To be circulated and held at a predetermined height, the liquid is propelled or thrust upward by a pump 146 to circulate the liquid 140 into a collecting port 142. The collecting port which may be positioned adjacent the downstream area and may cycle the liquid 140 through the collecting port 140 and downstream area 110b. The liquid 140 can be held at or elevated to a level sufficient to contact the bottom surface of the substrate 10. By doing so, the liquid 140 may overflow from the solder bath in the solder bath frame 110, and thus the collecting port 142 may be arranged to collect the overflown liquid 140.

The collecting port 142 may be arranged around or adjacent the downstream area 110b of the solder bath frame 110, and a lower portion of the collecting port 142 may be connected to the downstream area 110b of the solder bath frame 110 via a connection path 144 formed in the solder bath frame 110. The pump 146 may be arranged in the downstream area 110b of the solder bath frame 110 to raise or elevate the liquid 140 to a certain height within the downstream area 110b of the solder bath frame 110. Since the liquid 140 is upwardly flown to the substrate 10, both a buoyancy force Fb due to the characteristics of the liquid 140 and an upward flow force Fu generated by the upward flow of the liquid 140 may be applied to the molten solder 112 to adhere the molten solder 112 to the bottom surface of the substrate 10 to form solder bumps. This will be further described later.

As described above, the molten solder 112 and the liquid 140 may be stored together in the downstream area 110b of the solder bath 110. The liquid 140 may include oil or a flux, which does not chemically react with the molten solder 112 and is physically separated from the molten solder 112. The liquid 140 has a lower specific weight than the molten solder 112. Thus, the liquid 140 is physically separated from the molten solder 112 and lies above the surface of the molten solder 112.

Therefore, when molten solder 112 is re-cycled through the pump 134, only molten solder 112 is passed through the pump 134, not the liquid 140. The difference in chemical compositions between the molten solder 112 and liquid 140 allow the two substances to easily separate, leaving the molten solder 112 on the bottom of the solder bath frame 110, and the liquid 140 disposed above.

Meanwhile, in order to allow the liquid 140 to generate a greater buoyancy, it is desirable that the liquid 140 have a high specific weight. Thus, the liquid 140 may have a very high specific weight as long as the specific weight is lower than the specific weight of the molten solder 112. In addition, in order for the liquid 140 to maintain its liquid state in the downstream area 110b of the solder bath 110, the liquid 140 has a vaporization temperature higher than a melting temperature of the molten solder 112. For example, the vaporization temperature of the liquid 140 may be higher than the melting temperature of the molten solder 112 by about 50-100° C.

The wave soldering apparatus 100 according to the present embodiment may be used to form a solder bump 20 for a flip chip. In this case, a plurality of pads 12 may be arranged in the bottom surface of the substrate 10, and the molten solder 112 is adhered to the plurality of pads 12 so as to form solder bumps 20. In this procedure, the buoyancy force Fb due to the liquid 140 and the upward flow force Fu generated by the upward flow of the liquid 140 are applied to the molten solder 112, so that it is possible to form the solder bump 20 having a height sufficient to be used as a flip chip. The height of the solder bumps formed by the apparatus and method of the present general inventive concept is formed higher than the height would be if the buoyancy force Fb and upward flow force Fu were not applied, either together or separately. A reference numeral 14 in FIG. 2 indicates a flux that is coated on a surface of the substrate 10 except for the plurality of pads 12. The flux 14 may be arranged as flux units to separate the pads 12 from each other on a surface of the substrate.

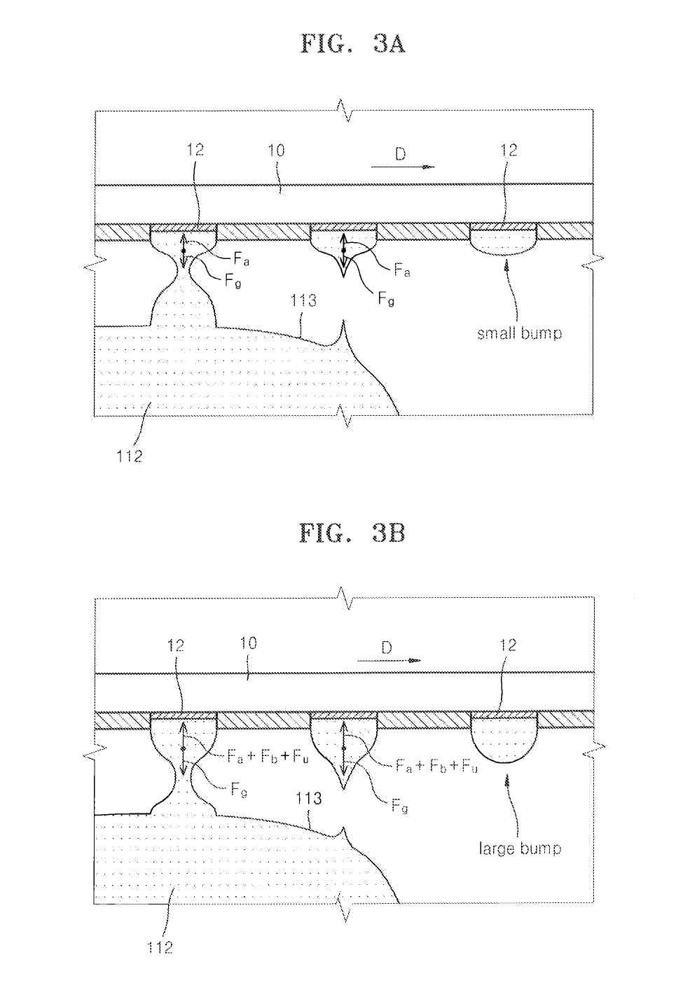

FIG. 3A illustrates a process in which the molten solder 112 is adhered to the substrate 10 when no buoyancy or upward flow forces are applied to the molten solder 112. FIG. 3B illustrates a process in which the molten solder 112 is adhered to the substrate 10 when a buoyancy and upward flow forces are applied to the molten solder 112 by the wave soldering apparatus 100 of FIG. 1.

Referring to FIG. 3A, when a surface of the wave 113 of the molten solder 112 contacts each pad 12 on the bottom surface of the substrate 10, the molten solder 112 is uniformly adhered to each pad 12. An adherence force Fa and a gravity force Fg acting in opposite directions are applied to the molten solder 112 that is adhered to each pad 12. As the substrate 10 moves in a direction marked by an arrow D, the molten solder 112 adhered to each pad 12 is detached from the surface of the wave 113. The molten solder 112 adhered to each pad 12 is acted upon by a resultant force of the adherence force Fa and the gravity force Fg. As illustrated in FIG. 3A, in a case where only the adherence force Fa and the gravity force Fg are applied to the molten solder 112 adhered to each pad 12, and no buoyancy force or upward flow force is applied to the molten solder 112, the amount of the molten solder 112 adhered to each pad 12 is small so that a small bump is formed. In this regard, the small bump has a low height that is insufficient to use as a small bump in a flip chip.

Referring to FIG. 3B, in the wave soldering apparatus 100 of FIG. 1, when the surface of the wave 113 of the molten solder 112 contacts each pad 12 on the bottom surface of the substrate 10, the molten solder 112 is uniformly adhered to each pad 12. Here, the adherence force Fa upwardly acting on each pad 12, and the gravity Fg downwardly acting are applied to the molten solder 112, and a buoyancy force Fb due to the liquid 140 is also applied to the molten solder 112. Factors involved in creating the buoyancy force Fb are the material, specific weight and vaporization temperature of the liquid 140. The buoyancy force Fb acts upwardly due to the upward movement of the liquid 140, and thus increases the amount of the molten solder 112 adhered to each pad 12. In addition, the upward flow force Fu generated by the upward flow of the liquid 140 may also be applied to the molten solder 112 adhered to each pad 12, and since the upward flow force Fu acts upwardly, the amount of the molten solder 112 adhered to each pad 12 may be further increased. As the substrate 10 moves in a direction marked by an arrow D, the molten solder 112 adhered to each pad 12 is detached from the surface of the wave 113. Here, the molten solder 112 adhered to each pad 12 is acted upon by a resultant force of the gravity force Fg and the sum of the adherence force Fa, the buoyancy force Fb due to the liquid 140, and the upward flow force Fu generated by the upward flow of the liquid 140. As described above, when the adherence force Fa, the buoyancy force Fb of the liquid 140, and the upward flow force Fu generated by the upward flow of the liquid 140 are applied to the molten solder 112 adhered to each pad 12, the remaining amount of the molten solder 112, which is adhered to each pad 12 after the molten solder 112 is detached from the surface of the wave 113, is significantly increased compared to the case of FIG. 3A. Thus, a large bump having a height sufficient to be used as a flip chip may be formed on each pad 12.

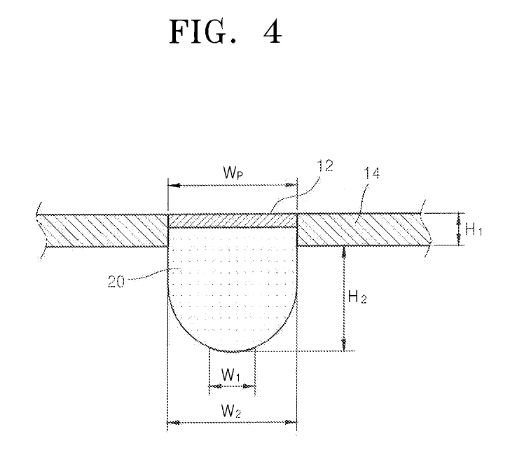

FIG. 4 illustrates an enlarged view of a solder bump formed on a substrate of the general inventive concept. According to embodiments of the present general inventive concept, heights of the solder bump 20 formed as a result of the buoyancy force Fb and upward flow force Fu are increased. For example, as illustrated in FIG. 4, the height H2 of the solder bump may extend up to two times the height of the flux 14. This is a significant difference than the solder bump illustrated in FIG. 3A, in which the height of the solder bump is merely the same height H1 as the flux 14. Also, the width W2 of the solder pad 20 may vary and taper from the edges of the solder pad 12 that border the flux 14, to a center thereof, and be narrower towards a width W1. As illustrated, the width W2 of the solder bump 20 may be the same as the width of the solder pad 12.

A method of forming solder bumps of the present general inventive concept will now be further described, along with examples heretofore described. As illustrated in FIGS. 1 and 2, a substrate 10 with pads 12 may be passed over the solder bath frame 110 that holds the solder bath, in the direction D. The substrate 10 may be passed by a conveyor or other implementation over the preliminary nozzle 122. Molten solder 112 may be pumped through the pump 132 and upwardly spouted out of the preliminary nozzle 122 to be adhered to the pads 12 of the substrate 10. The height of the solder bumps formed by the preliminary nozzle 122 is low, and these preliminary bumps may be formed as pre-cursors to the higher bumps formed by nozzle 124 illustrated in FIGS. 3B and 4.

After preliminary bumps are formed by the preliminary nozzle 122, the substrate 10 is transferred over the upstream area 110a to approach the nozzle 124. At the nozzle 124, additional molten solder 112 is applied to the preliminary bumps to form the bumps illustrated in FIG. 3B. As illustrated in FIG. 2, since the buoyancy force Fb and upward flow force Fu act upon molten solder 112 as the bumps are forming, the pressure placed on the forming bumps by the forces Fb and Fu, in addition to the adherence force Fa illustrated in FIG. 3B, result in a larger bump being formed than if the forces Fb and Fu had not been used. The additional forces Fb and Fu result from the upward flow of the liquid 140 pumped through the pump 146 into the collecting port 142, and guided through the connection path 144. The liquid 140 is continuously circulated in the downstream portion 110b.

Because of the specific weight of the liquid 140 relative to the specific weight of the molten solder 112, only molten solder is pumped through the pump 134 to be spouted out of the nozzle 124, and only the liquid 140 is circulated through the collecting port 142. If some molten solder does enter the collecting port 142, when cycled through the pump 146, the heavier molten solder 112 will sink to the bottom of the downstream area 110b to be re-cycled by the pump 134.

As illustrated in FIGS. 1 and 2, a quantity of the liquid 140 is circulated by the pump 146 to touch the bottom surface of the substrate 10 that borders the top surface of the solder bath frame 110 to form bumps having a high height. The present general inventive concept also includes that a height of the liquid 140 formed in the downstream area 110b may be held lower than the top height of the solder bath frame 110. To accomplish this, a lower volume of liquid 140 is entered into the solder bath frame 110. Thus, since the total height of the liquid does not totally surround the pads 12, the buoyancy force Fb and upward flow force Fu may be lessened, and thus the height of the bumps may be lessened to tailor the height of solder bumps to different flip chip and semiconductor package structures.

While the general inventive concept has been particularly illustrated and described with reference to exemplary embodiments thereof, it will be understood that various changes in form and details may be made therein without departing from the spirit and scope of the following claims.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A wave soldering apparatus comprising:
a solder bath frame containing molten solder in a solder bath;
a nozzle arranged in the solder bath frame to upwardly spout the molten solder toward a bottom surface of a substrate that passes an upper portion of the solder bath in the solder bath frame; and
a unit to contain a liquid different than molten solder in the solder bath frame to apply a buoyancy force of the liquid to the molten solder attached to the substrate.

2. The wave soldering apparatus of claim 1, wherein the liquid is held in a downstream area of the solder bath with respect to a moving direction of the substrate and the nozzle.

3. The wave soldering apparatus of claim 2, wherein a pump is arranged in the downstream area of the solder bath so as to make the liquid rise.

4. The wave soldering apparatus of claim 2, wherein a collecting port is arranged around the downstream area of the solder bath so as to collect the liquid that overflows from the solder bath.

5. The wave soldering apparatus of claim 4, wherein the collecting port is connected to the downstream area of the solder bath via a connection path that is formed in the solder bath of the solder bath frame.

6. The wave soldering apparatus of claim 2, wherein the liquid comprises oil or a flux, which does not chemically react with the molten solder and is physically separated from the molten solder.

7. The wave soldering apparatus of claim 6, wherein the liquid has a specific weight lower than a specific weight of the molten solder.

8. The wave soldering apparatus of claim 6, wherein the liquid has a vaporization temperature higher than a melting temperature of the molten solder.

9. The wave soldering apparatus of claim 1, wherein a preliminary nozzle is arranged in an upstream area of the solder bath with respect to a moving direction of the substrate and the nozzle.

10. A soldering method comprising:
upwardly spouting a molten solder toward a bottom surface of a substrate that passes an upper portion of a solder bath containing the molten solder, and adhering the molten solder to a bottom surface of the substrate; and
applying a buoyancy force to the molten solder to adhere the solder to the bottom surface of the substrate to form a plurality of solder bumps.

11. The soldering method of claim 10, wherein the solder bath contains a liquid that does not chemically react with the molten solder and is physically separated from the molten solder, and wherein the buoyancy force is applied to the molten solder by the liquid.

12. The soldering method of claim 11, further comprising raising the liquid and then applying an upward flow force generated by an upward flow of the liquid to the molten solder that is adhered to the bottom surface of the substrate.

13. The soldering method of claim 11, wherein the liquid comprises oil or a flux.

14. A method of forming a solder bump for a flip chip, the method comprising forming the solder bump by attaching the molten solder to a plurality of pads formed on the bottom surface of the substrate by performing the soldering method of any one of claims 10-13.

15. The soldering method of claim 10, wherein the application of the buoyancy force increases a height of the formed solder bumps to a height greater than a height that would result without the application of the force.

16. The soldering method of claim 11, wherein the liquid has a specific weight lower than a specific weight of the molten solder.

17. An apparatus to form solder bumps on a substrate comprising:
a solder bath frame to hold a solder bath including molten solder;
a first nozzle positioned in an upstream area of the solder bath frame to form a preliminary solder bump on the substrate;
a second nozzle positioned in a downstream area of the solder bath frame to form a secondary solder bump on the preliminary bump; and
a collecting port adjacent the downstream area to cycle a liquid different from the molten solder through the collecting port and downstream area.

18. The apparatus of claim 17, further comprising:
a pump arranged in the downstream area of the solder bath frame to raise the liquid to a predetermined height adjacent a top of the solder bath frame within the downstream area.

19. The apparatus of claim 18, wherein the molten solder accumulates at a bottom of the solder bath frame and the liquid accumulates above the molten solder based on an absence of a chemical reaction between the molten solder and the liquid.

20. The apparatus of claim 17, wherein a height of the solder bumps is increased as a result of a buoyancy force and an upward flow force of the liquid.

21. A substrate formed by upwardly spouting a molten solder toward a bottom surface of a substrate that passes an upper portion of a solder bath containing the molten solder, and adhering the molten solder to a bottom surface of the substrate and applying a buoyancy force to the molten solder to adhere the solder to the bottom surface of the substrate to form a plurality of solder bumps.

22. A substrate comprising:
a body;
a bottom surface of the body formed with at least one pad thereon separated by a plurality of flux units; and
a solder bump formed on the pad, the solder bump having a width that tapers toward the center and a height significantly higher than the flux units.
